(19) United States
(12) Patent Application Publication
(10) Pub. No.: US 2005/0216884 A1
(43) Pub. Date: Sep. 29, 2005

(54) Object generation

(75) Inventor: Alan Tchochiev, Seattle, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Microsoft Corporation

(21) Appl. No.: 10/809,247

(22) Filed: Mar. 25, 2004

(51) Int. Cl. G06F 9/44

(52) U.S. Cl. 717/106; 717/114

(57) ABSTRACT

A method of incrementation is provided, which allows the value of a property associated with a task to be changed (incremented) during consecutive executions of the task. A base generator class containing common functionalities needed by software tools is provided. The base generator class also incorporates the concept of incrementation. Generators for performing a specific task that inherits the base generator class are created. The settings of the generator are customizable prior to execution, either through a user interface or programmatically. The customized settings may be saved and reused.

### FIELD OF THE INVENTION

The present invention relates to computer programs and, in particular, to a method for object generation using a base generator.

### BACKGROUND OF THE INVENTION

In today's software development cycle, writing applications that can perform similar actions multiple times is a constant need. For example, during stress, scale, or performance testing, an engineer may need to create thousands of files with similar names but distinguishable by a slight variation in the names. For example, such an engineer may want to create a thousand files all with names starting with the letters FileA, but ending with a suffix ascending in numerical order, such as 1, 2, 3 . . . 999, 1000.

Software developers have written tools to satisfy the need to perform similar actions multiple times. More specifically, FIG. 1 shows many tools 102 . . . 122 . . . 132, each designed to perform a different task 104A . . . 104N . . . 104Z. Each tool exists in its own universe. That is, each tool contains its own unique set of task property management, user interface, scheduling management, status window, and logging options. For example, tool A 102, tool N 122, and tool Z 132 all contain the functionalities required to manage the corresponding task properties 107A, 107N, 107Z, user interfaces 108A, 108N, 108Z for a user to enter input for performing the corresponding task, and status indicators 110A, 110N, 110Z for informing a user of the status of executing a task. These tools 102, 112, 132 also include logging mechanisms 112A, 112N, 112Z that detail the execution process and the errors generated in using a tool. These tools 102, 112, 132 further include descriptions 114A, 114N, 114Z of the corresponding task, and task properties. These features generally have the same or similar functionalities, though they may be implemented differently. Additionally, some tools such as tool N 122 may contain features not implemented by other tools, such as scheduling functionality 116N. Yet, such a feature may be useful to other tools as well.

Individually implementing common functionalities in a plurality of tools creates a huge amount of development effort redundancy. For example, most software tools require a user interface for receiving user data and instructions and supplying users with a status report of task execution. Many tools also require the ability to schedule the execution of a tool, and the ability to log the progress of tool execution. Requiring a tool developer to generate code for these functionalities each time the developer writes a tool program is not an efficient use of time and resources.

Furthermore, over time, the users of a tool may want to add new task properties to the tool. For example, user X may need to add properties, such as file name and file size to a tool that performs the task of creating files. User Y may need to add properties such as location and file type to the same tool. When different users add different properties to the same tool, over time, the properties may become incoherent and difficult to decipher.

In addition, users of a tool usually have little ability to change values of task properties. The developer of a tool generally sets the values of task properties and variation over these values in the source code of a tool. As a result, in the past, users of such tools have had a very limited ability to control how property values change. For example, when using a “Create File” tool, a user may want the name of created files to change in a certain numerical order, plus certain offsets, at certain intervals. A user may also want to restart the file name from a certain value after creating a certain number of files. This type of property value variation is usually not provided by previously developed tools. Even if provided, a user's ability to make a property value variation is usually very limited.

As a result, there is a need for a way to eliminate the necessity for a tool developer to recreate common features of development tools over and over again. There is also a need for a way to enable a tool to easily combine or contain a superset of functionality provided by existing tool. Further, there is a need for a tool that gives a user sufficient flexibility and control over the management of task properties, including the ability to control how property values change between consecutive executions of a task. This invention is directed to addressing these needs.

### SUMMARY OF THE INVENTION

In accordance with the present invention, a method and a computer-readable medium containing computer-executable instructions for a method of varying the value of a property associated with a task during consecutive executions of the task are provided. This method permits the value of a property associated with a task to vary during consecutive executions of the task. The method also creates settings associated with a property that control how the value of the property may vary during consecutive executions of the task. The method further allows a user executing the task to customize these settings according to user preference.

In accordance with the present invention, a computer-readable medium containing a data structure called a base generator class is provided. An exemplary implementation of the base generator class comprises a base generator class constructor, a generator properties object that provides incrementation capability, a status indicator, a schedule object, and a logging object.

In accordance with further aspects of the present invention, a method of using the base generator class incorporating the incrementation concept to create generators (i.e., tools) for accomplishing specific tasks is provided. The method involves (1) creating a new generator class that inherits the base generator class; (2) creating a public default constructor (i.e., a public constructor that takes no parameters) for the new generator class; and (3) creating a function in the new generator class that performs the specific task for which the generator is designed. The public default constructor overrides the base generator class constructor and establishes all properties associated with the generator and their settings.

In accordance with other aspects of this invention, a method is provided for using a generator. The method involves customizing the settings of a generator, such as generator property settings which includes incrementation settings, scheduling, logging, etc., either through a user interface or programmatically. The method also involves the execution of a generator with the customized settings, either through a user interface or programmatically.

In accordance with other aspects of this invention, a method is provided for creating and using a generator. The method includes creating a new generator class for performing a specific task that inherits the base generator class that incorporates the incrementation concept. The method further includes customizing the settings of the generator using an object generator user interface or programmatically. The generator with customized settings is executable using an object generator user interface or programmatically.

In summary, the present invention provides the incrementation capability, which enables a user of a tool to vary the values of the properties associated with a task between consecutive executions of a task, resulting in objects generated by the tool to have differentiable property values. The present invention further streamlines the software tool development process by abstracting the common functionalities of software tools into a base generator class. This abstraction enables software tool developers to focus only on the specific task a tool is designed to implement and the properties associated with the task. The base generator class also incorporates the method of incrementation. The present invention also gives users the flexibility to customize the settings of a generator, which includes settings for incrementation, either through a user interface or programmatically. The present invention further allows a user to save and reuse customized generator settings. At last, the present invention enables a user to use a generator for object generation through a user interface or programmatically.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a system diagram illustrating the conventional way of creating software tooling for specific tasks;

FIG. 2 is a system diagram illustrating an exemplary embodiment of the present invention;

FIG. 3A is a system diagram illustrating an exemplary embodiment of a base generator class;

FIG. 3B is a system diagram illustrating the concept of incrementation;

FIG. 4 is an exemplary program illustrating the implementation of a generator;

FIGS. 5A-5B are exemplary object generator user interface diagrams;

FIG. 6 is an exemplary program for customizing generator settings programmatically;

FIG. 7 is a functional flow diagram illustrating an exemplary method of object generation using a base generator class;

FIG. 8 is a functional flow diagram illustrating an exemplary method of creating a generator that inherits from a base generator class to perform a specific task process, suitable for use in FIG. 7;

FIG. 9 is a functional flow diagram illustrating an exemplary method of creating a public default constructor that overrides the base generator class constructor, suitable for use in FIG. 8;

FIG. 10 is a functional flow diagram illustrating an exemplary method of customizing generator settings through a user interface, suitable for use in FIG. 7;

FIG. 10A is a functional flow diagram illustrating an exemplary method of selecting a generator, suitable for use in FIG. 10;

FIG. 10B is a functional flow diagram illustrating an exemplary method of customizing the properties of the generator, suitable for use in FIG. 10;

FIG. 10C is a functional flow diagram illustrating an exemplary method of setting schedule and logging options for executing a generator, suitable for use in FIG. 10; and

FIGS. 11-15 are functional flow diagrams of exemplary methods of customizing generator settings programmatically, suitable for use in FIG. 5.

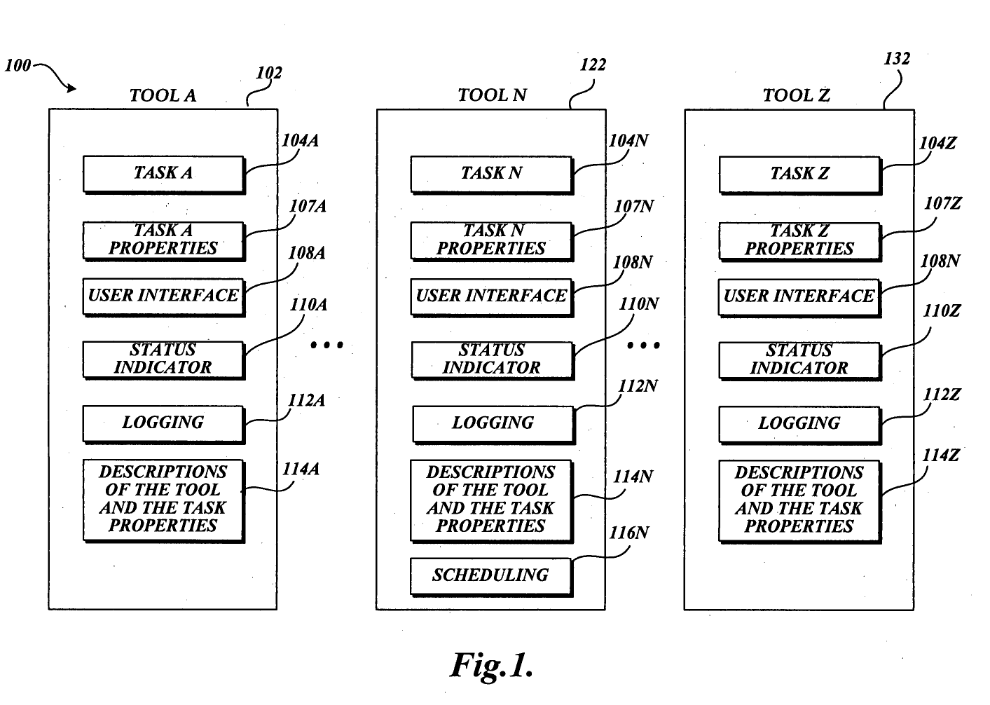

### DETAILED DESCRIPTION OF THE PREFERRED EMBODIMENT

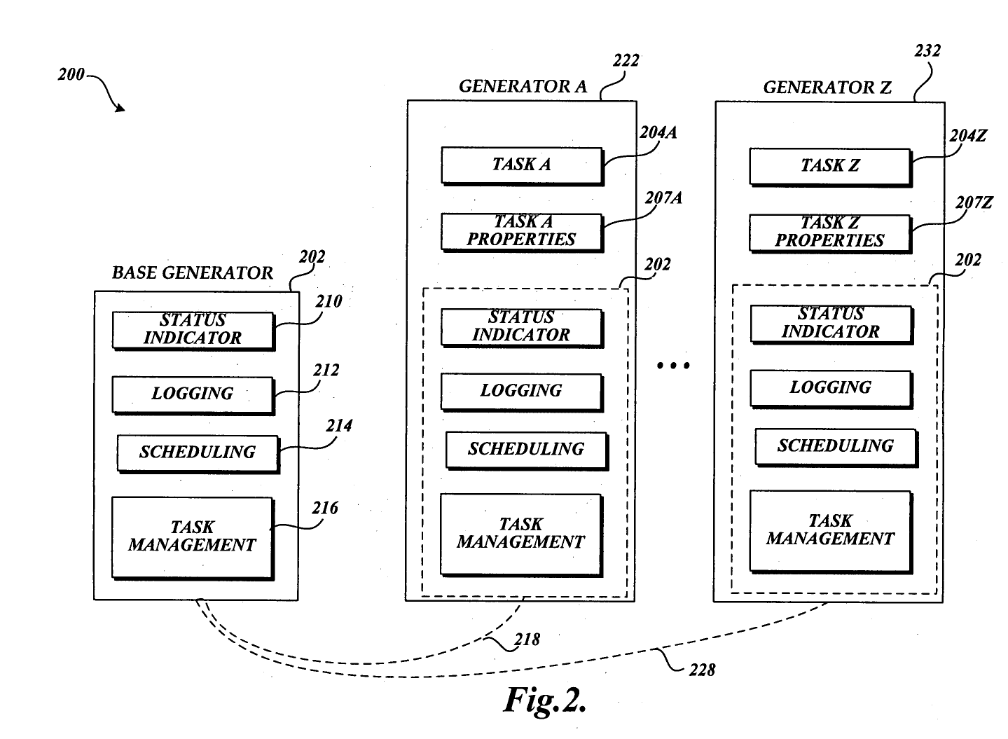

Various embodiments of the present invention provide a framework 200 that allows easy development of software tools or modules intended for performing similar actions multiple times. As illustrated in FIG. 2, the framework 200 includes a base generator 202 that contains functionalities needed to streamline the tool development process. These functionalities include, but should not be constructed as limited to, a status indicator 210, logging 212, scheduling 214, and task management 216. Task management 216 include providing a description of a task and managing properties associated with the task. Developers can use the base generator to create different generators (tools) 222 . . . 232 that inherit 218 . . . 228 the base generator's functionalities. In this way, tool developers only need to write code for performing specific tasks 204A . . . 204Z and setting up the properties 207A . . . 207Z associated with these tasks 204A . . . 204Z once. Each thusly-created generator performs a specific task. Users can use a thusly-created generator to perform a similar task multiple times by customizing the generator's settings such as generator properties, schedule, logging options, etc. A user can customize and use a generator either through a user interface or programmatically, i.e., by coding.

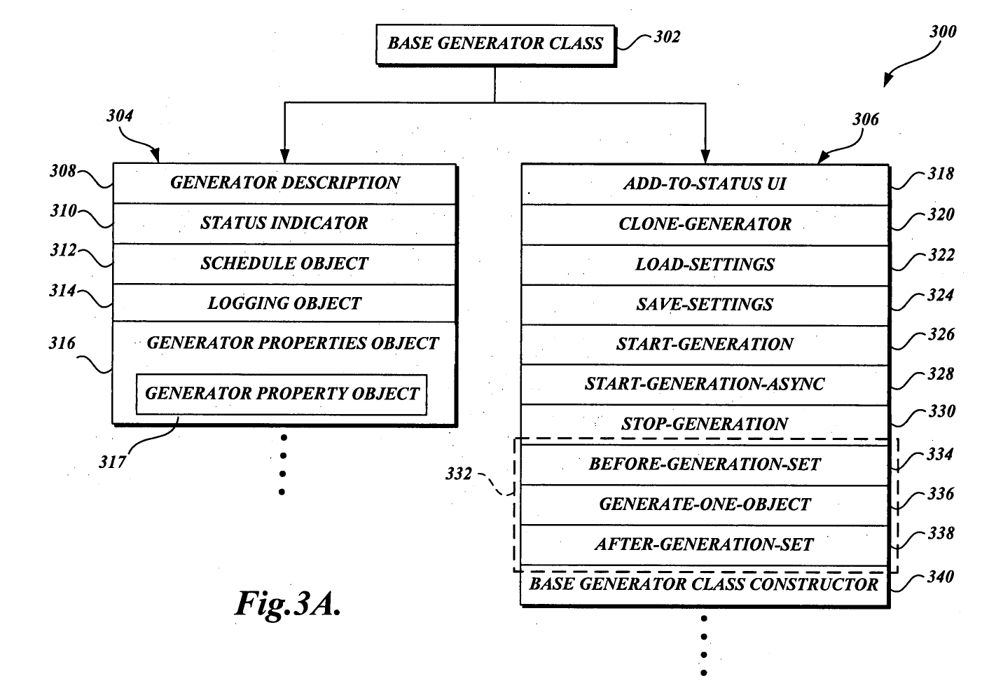

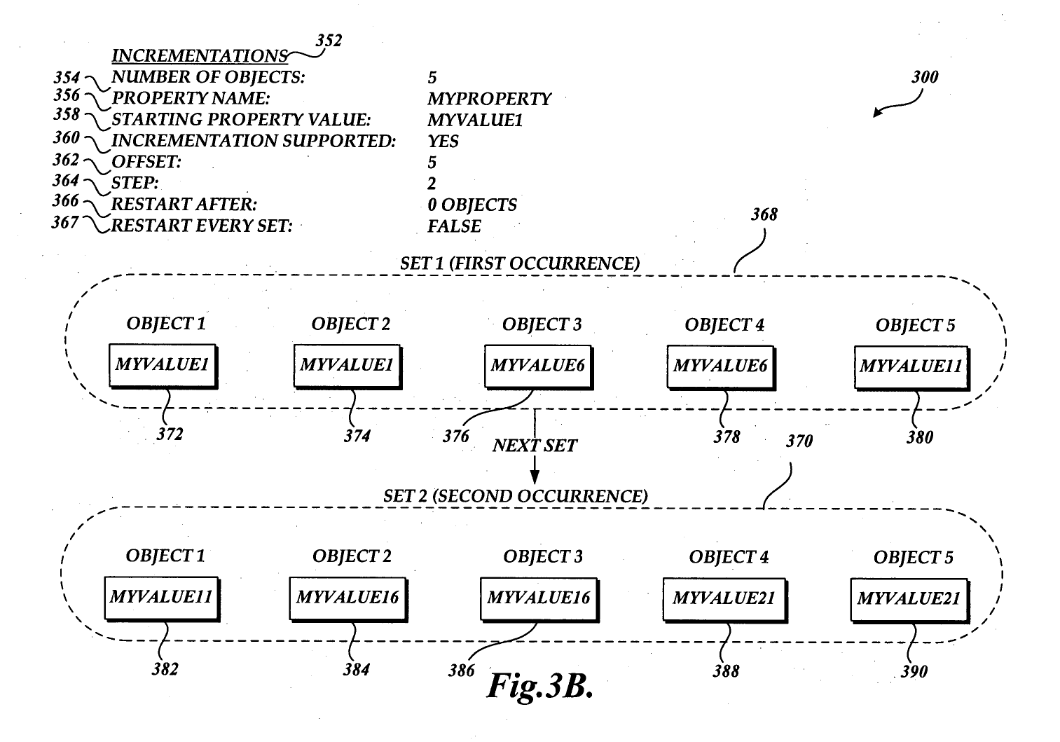

FIG. 3A illustrates an exemplary embodiment of a base generator 300. Here, the base generator 300 is implemented as a base generator class 302. The base generator class 302 includes a plurality of class properties 304 and class methods 306 for accomplishing the functionalities that are commonly required by different tools.

The base generator class methods 306 include methods for managing the object generation process. A few examples of such methods are shown in FIG. 3A. An add-to-status UI method 318 adds a generator to the status user interface (UI) if one is shown. A clone-generator method 320 creates an exact copy of the current generator. A load-settings method 322 loads all saved generators and their corresponding generator settings from a file. A save-settings method 324, on the contrary, saves all loaded generators and their corresponding generator settings into a file.

A start-generation method 326 and a start-generation-async method 328 enable a user to start object generation synchronously or asynchronously, respectively. In both cases, a new thread is created that stays active until the generator to which it corresponds gets disposed. A stop-generation method 330 stops an asynchronous object generation.

The illustrated base generator class 302 also includes three methods 332 that must be overridden in classes that inherit from this class. These methods 332 are invoked automatically by the base generator class 302. A before-generation-set method 334 contains any code that needs to be executed before each set of objects is generated. A “set” is a single execution of any given generator. If a generator has a recurrence pattern of execution, every occurrence is a separate set. A generate-one-object method 336 contains code that performs the generation of one object. An “object” is a single operation performed by any given generator. For example, for a generator that creates files, an object would be the creation of a single file. An after-generation-set method 338 contains any code that needs to be executed after each set of objects is generated.

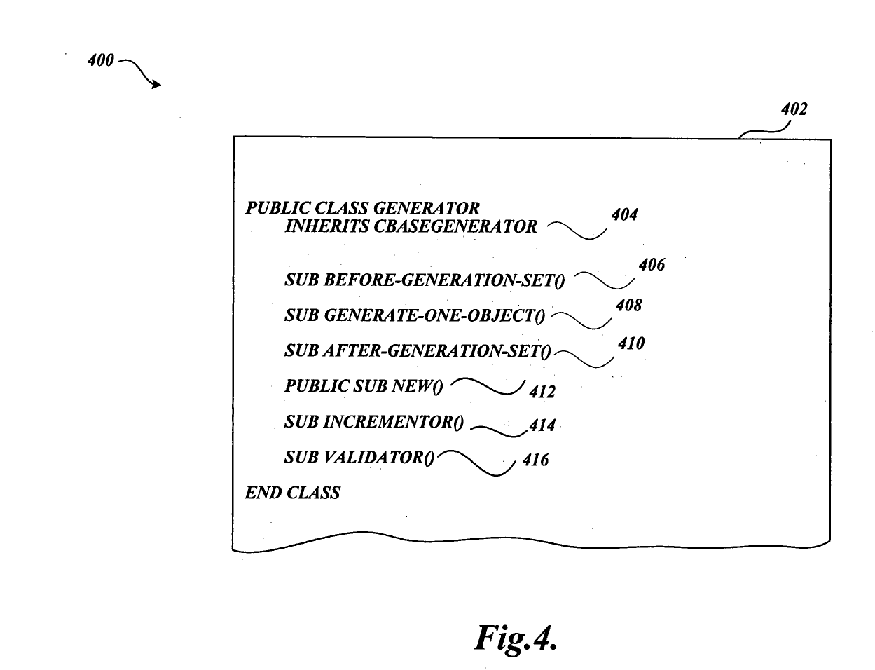

The base generator class 302 also includes a base generator class constructor method 340 that is used to initialize a generator. In one exemplary implementation, the base generator class constructor method 340 uses the name and the description of a generator as parameters. When implementing a generator class inheriting from the base generator class, there must be a public and default (no parameters) overload of the base generator class constructor 340. More details on overloading the base generator class constructor method 340 are provided in the following discussion of implementing a generator (FIG. 4).

The base generator class 302 also includes class properties 304, such as a generator description 308, status indicator 310, a schedule object 312, a logging object 314, and a generator properties object 316 that encompasses all the properties of the generator, etc.

The status indicator 310 includes a status UI that displays the execution status of generators. The status UI may be employed, either through user input or programmatically.

The schedule object 312 allows a user to specify when or after which condition a generator should start or end and a generator's recurrence pattern, if there is any. One exemplary implementation of the schedule object 312 includes a start condition that needs to be fulfilled before object generation can occur. A start condition may be a specific time when a generator should be started; an amount of time that needs to pass after the generator has been invoked before the generator can be started; or an instantaneous start by the generator as soon as it is invoked. The execution of a generator may be scheduled to occur one time only, recur weekly or monthly, or recur after any given amount of time. The schedule object 312 may also include an end condition that, once fulfilled, will indicate that no further occurrences of the schedule will take place. The ending of an execution of a generator may be at a specific time, after a certain amount of time, or after a given amount of objects. The schedule object 312 may further include a dialog box that can be used to configure all schedule settings.

The logging object 314 enables the recording of what objects were generated, at what time, and using what properties. In one exemplary implementation of a logging object 314, structured query language (SQL) logging is used. For example, a database consisting of tables is used to store the logging information. One table is for each generator enabled for logging.

The logging functionality may be turned on or off by a user of a generator. The data resulted from using the logging object 314 may be used by a verification process to verify what objects were generated with what generator settings. The logging object 314 may also include a field that indicates whether a verification process has run on a generated object. In this way, the next time the verification process is run, it can skip the generated objects that are marked as having been verified.

As noted above, the base generator class 302 further contains a generator properties object 316. The generator properties object manages all of the properties associated with the current generator. Each generator can have one or more properties that is specific to the type of work the generator performs. The generator properties object 316 manages the generator properties by keeping track of the number of properties defined for a generator, which generator owns the properties, adding or removing individual properties, etc.

In one embodiment of the present invention, the generator properties object 316 constitutes a generator property object 317. The generator property object 317 represents an individual property. A generator property object 317 may contain a corresponding property description that describes the purpose of the property. A property may be defined as read-only, which means that a user of a generator cannot modify the property settings. The setting of a property may be cloned (copied) from one property into another property.

The generator property object 317 also contains the value of a property. The value of a property may be a string value or a non-string value, which can be anything, such as a binary block of data or a reference to an instance of a class.

The generator property object 317 may also contain properties and methods that enable a property value to vary from one generated object to the next. Because a generator may be used repeatedly to generate multiple objects, variation in property value may be needed on each object. The process to change a property value from one object to the next is called incrementation. For example, when a user uses a “Create File” generator to create 1000 files, the user may prefer to have the file names be differentiable. Incrementation is employed to change the value of property “FileName” from one file object to the next.

In one embodiment of incrementation of object generation, the value of a property is split into two parts—a stream portion and a numerical portion-the second portion is then incremented based on the incrementation settings and methods provided in a generator property object 317.

FIG. 3B exemplifies the settings for incrementation 352. Here, the generator has a property name 356 called MYPROPERTY, which has a starting property value 358 called MYVALUE1. Further, each object generation occurrence is set to generate a number 354 of 5 objects. As a result, the first occurrence 368 generates a first set of five objects 372-380, and the second occurrence 370 generates a second set of five objects 382-390, etc.

The setting of an “incrementation supported” toggle 360 indicates whether or not the incrementation capability is supported or not supported. The developer creating a generator controls this setting. For example, a property “username” that will be used to establish a connection to a specific source, probably is not allowed to be incremented from one object to the next object. Further, even if a developer creating a generator allows incrementation to be supported on a property of the generator, incrementation on the property may be disabled by a user of the generator.

The setting of an “offset” value 362 controls how much a property value may be incremented during each incrementation. For example, in FIG. 3B, the offset 362 for incrementation is 5. Thus, for a starting property value MYVALUE1, the next value after incrementation will be MYVALUE6, then MYVALUE11, etc.

The setting of a “step” value 364 controls how many objects should contain the current property value before the property value is incremented. For example, in FIG. 3B, the “step” setting is 2; incrementation therefore occurs on every third object.

The setting of a “restart after” value 366 controls how many objects should be generated before the property value returns back to the starting property value 358 during each set of object generation. If this setting is 0, the property value will not return back to the starting property value 358 in each scheduled occurrence 368, 370 of the generator execution. In contrast, if this setting is 3, the property value of every fourth object in one scheduled occurrence will return to the starting property value 358.

The setting of a “restart every set” toggle 367 is only relevant when the generator has a recurring schedule. This setting controls whether a property value should return to the starting property value 358 after each occurrence. For example, In FIG. 3B, the “restart every set” toggle 367 is set to FALSE. Hence, in the second occurrence 370, the property value of the first object 382 is MYVALUE 11, which is the same as the value of the last object 380 in the first occurrence 368, instead of the starting property value 358 MYVALUE1.

The generator property object 317 further contains a default property incrementor method that increments strings, IP addresses, Media Access Control (MAC) addresses, and some other common values. A developer implementing a generator may implement a custom property incrementor for a generator property if the property value is to be incremented in some specific way. For example, a developer for a “Create File” generator may want to increment only the numeric portion of property value “file-1.txt.” The developer hence needs to implement a custom property incrementor method to perform such an incrementation.

The generator property object 317 also contains a validator method to validate the value of a property. A validator method may be used on a property regardless whether incrementation is supported on the property. By default, no validation is performed.

A developer implementing a generator may implement a custom property validator method for a generator property. For example, the developer of the “Create File” generator may implement a custom property validator method for the property “file name” to ensure that the value of “file name” is a valid property value. A developer who implements a custom property incrementor method does not have to implement a custom property validator if the developer thinks no validation on a changed property value is necessary.

FIG. 4 illustrates one embodiment of implementing a generator using the base generator discussed above. Here, a new generator class is created. The new generator class inherits the base generator class 404. Then, the three methods defined by the base generator, namely, a before-generation-set method 406, a generate-one-object method 408, and an after-generation-set is overridden to perform the specific task the generator is designed for.

Next, a public default constructor 412 (a public constructor that takes no parameters) for the new generator class is created to override the base generator class constructor. In the public default constructor, the base generator class is initialized with the name and the description of the generator; generator properties are defined by specifying the name, description, and default value of each property.

If a property value needs to be incremented in some custom way, a custom property incrementor method 414 may be implemented.

A custom property validator method 416 may also be implemented to validate a property value.

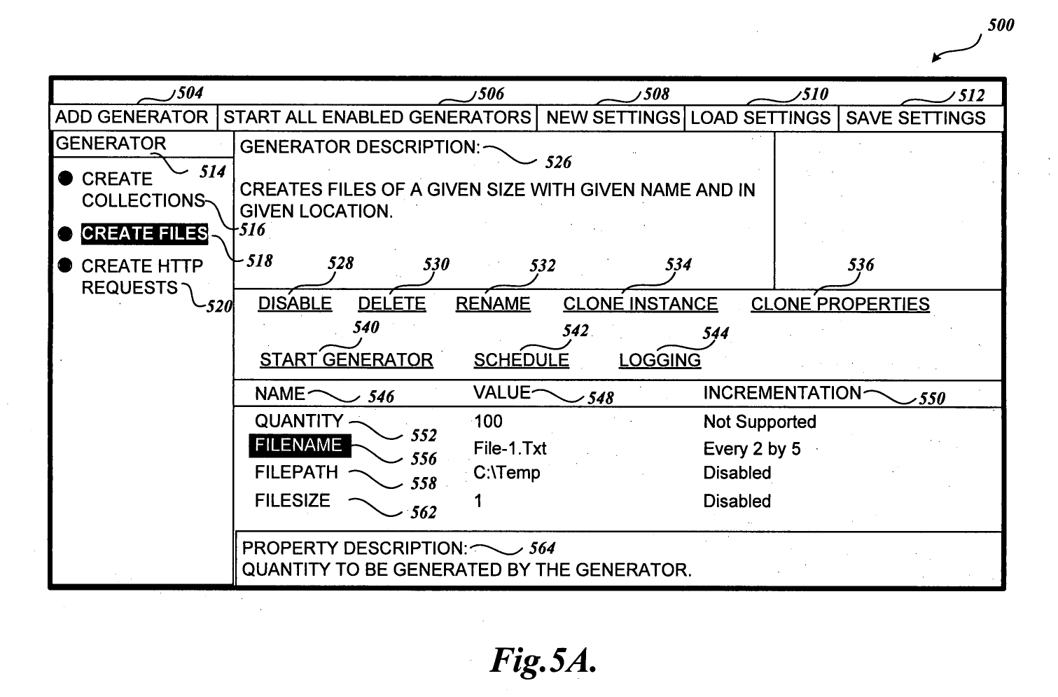

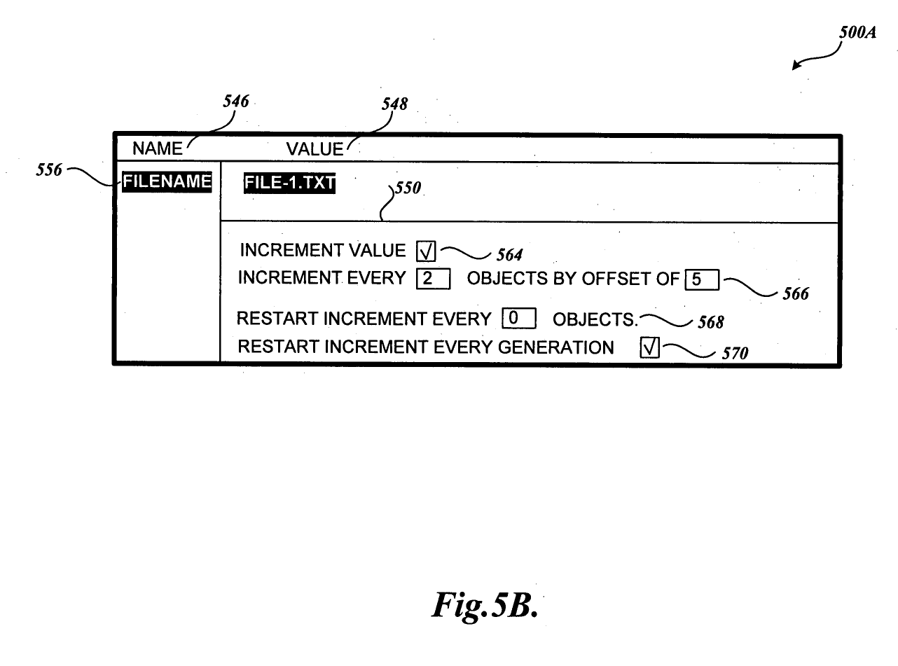

A generator may be invoked either through a user interface or programmatically. FIGS. 5A-5B illustrate one embodiment of a user interface for object generation. A user may “add generator” 504 to the user interface 500 from files containing one or more generators. A user may enable one or more generators by selecting the generators listed in a generator panel 514. The illustrated generator panel 514 includes three generators-“Create Collections” 516, “Create File” 518, and “Create HTTP Requests” 520. A user can enable any one, a combination, or all of the generators by selecting the appropriate generators. All enabled generators are executed by a user selecting a “Start All Enabled Generators” 506 button. Each enabled generator can be started individually by using a “Start Generator” 540 link.

A “New Settings” 508 command allows a user to create a new file and clear out all existing loaded generators so that the user can start adding new generators from scratch. A “Load Settings” 510 command retrieves all saved generator and their corresponding settings from a file. A “Save Settings” 512 command saves all loaded generators and their corresponding settings to a file.

After a user selects a generator, the user interface 500 displays the generator description 526. In the illustrated example, the user has selected the “Create Files” 518 generator and the generator description is defined as “Creates files of a given size with a given name in a given location.” The user can choose to disable 528, delete 530, or rename 532 the generator. The user can also create a new instance of the generator by selecting a “clone instance” link 534, or copy the properties of a generator to another generator by selecting a “clone properties” link 536. Further, a user can invoke a schedule dialog box by selecting a “schedule” link 542. Finally, a user can invoke a logging dialog box by selecting a “logging” link 544. The scheduling and logging dialog boxes set scheduling and logging options for object generation.

The user interface 500 also displays the settings of properties associated with a generator. For example, after a user selects the generator “Create Files” 518 in the generator panel 514, the user interface 500 displays the names 546 of the properties associated with the “Create Files” generator: Quantity 552, file name 556, file path 558, and file size 562. The user interface 500 also displays the current value 548 of each property and the associated incrementation settings 550 of each property. For example, Quantity 552 may have a value of 100; incrementation is not supported on the value of quantity 552. Further, file name 556 may have a value of “file-1.txt”; and this value may be set to be incremented by 5 every two file objects. Lastly, file path 558 and file size 562 may have a value of “C:\temp” and “1(MB)”, respectively. A user may disable the incrementation ability on the values of both file path 558 and file size 562 if the user does not want the values to change over a course of creating files.

A user can also customize the generator properties through the user interface 500. Generator properties are customized by highlighting a property name 546, such as FileName 556. The user interface 500 displays a description 564 for the selected property. The user may then customize the corresponding property value 548 and its associated incrementation settings 550 by double-clicking the selected property name. FIG. 5B further illustrates how in one exemplary embodiment of the present invention a value 548 of a property 546 and its associated incrementation settings 550 are customized through a user interface 500A, an extension of user interface 500. The user first specifies the value 548 of the selected property “FileName” 556 to be, for instance, FILE-1.TXT. The user then enables incrementation by setting an “increment value” toggle 564 to TRUE. The names of the generated files are incremented by 5 every two files by the user filling in the blanks in “increment every_objects by offset of” 566 with the numbers 2 and 5, respectively. No return to the starting property value occurs during each occurrence of object generation because the user has specified 0 in the blank in “restart increment every_object” 568. The starting property value will be used at the beginning of every object generation occurrence because a “restart increment Every Generation” toggle is set to TRUE. After customizing all the settings for a generator, a user may initiate the generation by selecting the “start generator” 540 link shown in FIG. 5A.

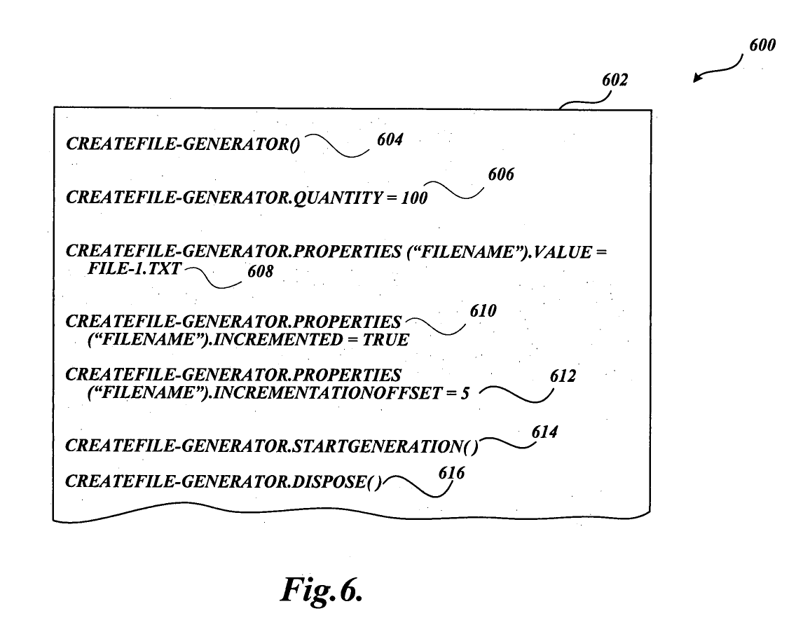

The use of an object generator user interface 500 is optional because a user of a generator can also deploy a generator programmatically, i.e., by coding. FIG. 6 illustrates exemplary code for deploying a generator programmatically. First, the user initiates the generator by calling its public default constructor identified in this example as CreateFile-Generator( ) 604. Next, the user proceeds to set the property values for the generator. For example, the user sets the number of files to be generated to be 100 in “CreateFile-Generator.quantity=100” 606. The user also sets the “FileName” property value to be FILE-1.TXT.in “CreateFile-Generator.properties(“FileName”).value=FILE-1-.TXT” 608. Incrementation is implemented programmatically by a user enabling the incrementation capacity of a generator property in “CreateFile-Generator.properties(“FileName”).incremented=True” 610. The user can then specify other incrementation settings, such as offset, step, restart, etc. In this example, the offset setting is specified to be 5 in “CreateFile-Generator.properties(“FileName”).incrementationoffset=5” 612. After setting the property values and property settings, the user can program the object generation process to start in “CreateFile-Generator.startgeneration( )” 614. After an object generation process completes, a user may modify generator settings and start object generation again. A user may also program to dispose the generator in CreateFile-Generator.dispose( )” 616.

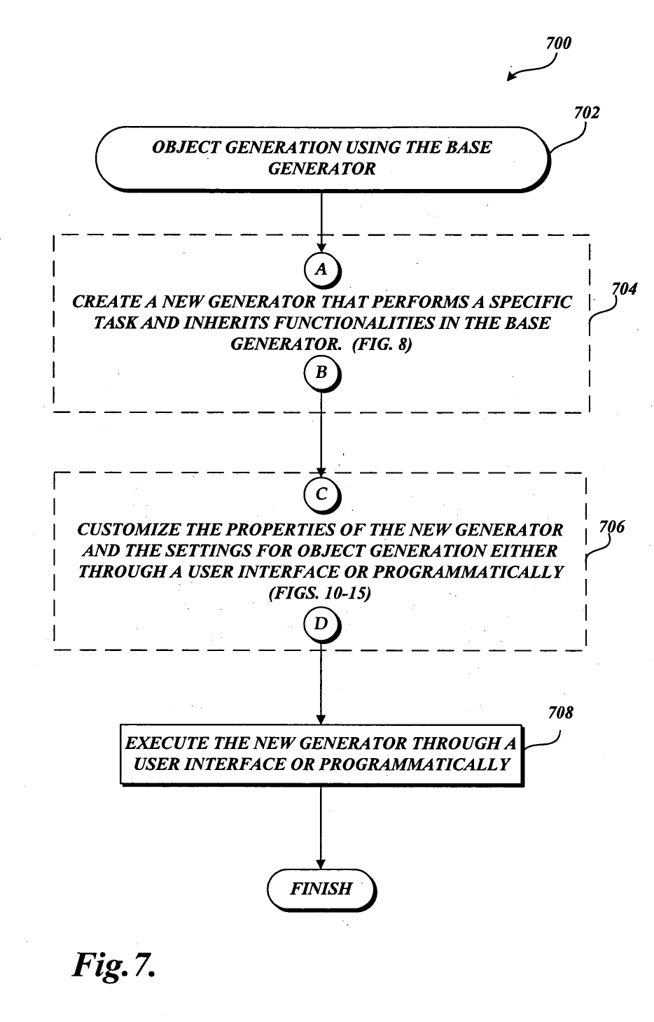

FIGS. 7-15 illustrate a method 700 of object generation employing a base generator. In general, the method comprises authoring a generator that performs a specific task; customizing the settings of the generator, either through a user interface or programmatically; and executing the generator with the customized settings, either through a user interface or programmatically.

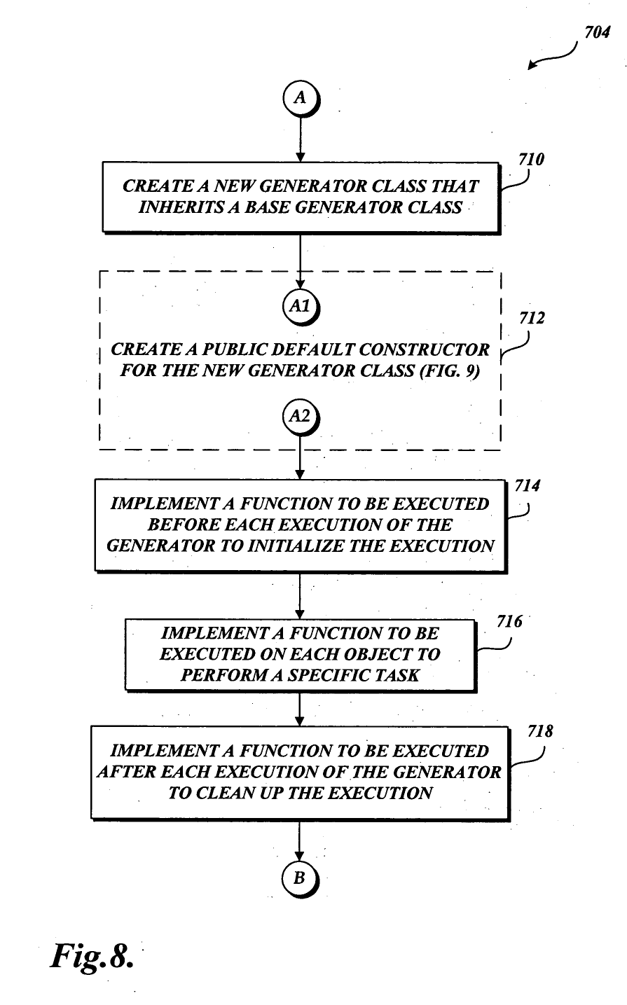

From a start block, the method 700 proceeds to a process 704, defined between a continuation terminal (“terminal A”) and an exit terminal (“terminal B”), for creating a new generator for performing a specific task that inherits functionalities from the base generator. FIG. 8 illustrates a suitable process 704.

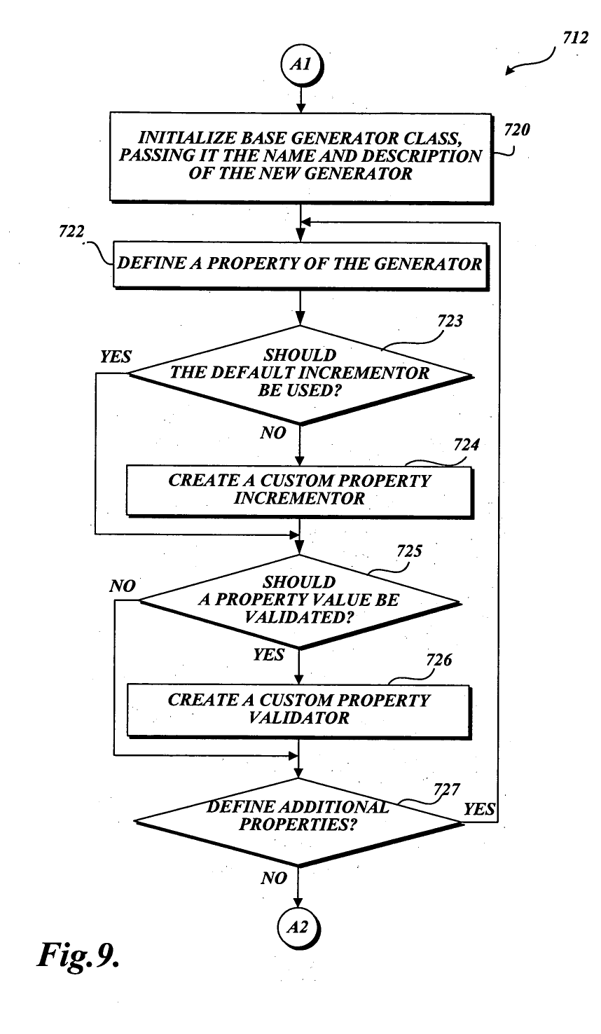

From terminal A (FIG. 8), the process 704 proceeds to block 710, where the method creates a new generator class that inherits the base generator class. The process 704 then proceeds to a process 712, defined between a continuation terminal (“terminal A1”) and an exit terminal (“terminal A2”). The process 712 creates a public default constructor for the new generator class that overrides the base generator class constructor. FIG. 9 illustrates a suitable process 712.

From terminal A1 (FIG. 9), the process 712 first initializes the base generator class, passing it the name and a description of the new generator to be created. See block 720. For example, to create the generator “Create Files,” the process 712 initializes the base generator class, passing it the generator name “Create File” and a description of the generator namely, “creates files of a given size with a given name and in the given location.” Next, the process 712 defines each property the new generator will use. See block 722. To define a property, the process 712 provides the name of the property, a default value for the property, and a description for the property.

For each incrementable property, a test is made to determine if default incrementor is to be used. See decision block 723. By default, a incrementable property uses a default incrementor supplied by the base generator class, unless the property value is to be incremented in some custom way. If the answer to decision block 723 is “no”, a custom property incrementor method is created. See block 724. For example, a developer of the generator “Create Files” 518 illustrated in FIG. 5A may want to create customer incrementor methods to increment the values 548 of properties “file name” 556, “file path” 558, and “file size” 562, if the developer wants to increment these property values in some custom way.

If a developer decides to use a default incrementor for an incrementable property ( a “yes” answer to decision block 723), or after a developer implements a necessary custom property incrementor method, the process 712 proceeds to check if a value of the property should be validated. See decision block 725. If the answer is “yes”, since the default validator provided by the base generator class performs no validation, a custom property validator method is created for the property to validate each property value. See block 726.

If no validation on property value is necessary (“no” answer to decision block 725) or after a developer implements a necessary custom property validator, the process 712 proceeds to check if additional properties need to be defined. See decision block 727. If the answer is “yes”, the process 712 loops back to block 722 to define another property. If the answer is “no”, the process 712 exits through terminal A2.

If a developer decides not to have incrementation support on a property value, i.e., the property is not incrementable, then no custom property incrementor method is needed. However, the developer may still implement a custom property validator if the developer decides to validate a property value.

From terminal A2 (FIG. 8), the process 704 proceeds to implement a function containing any code which needs to be executed before each occurrence of object generation. See block 714. For example, for a “Create File” generator, the function implemented in block 714 may create network connection to a server specified by the generator property “file path”. The process 704 then proceeds to implement a function to be executed on each object generated from this generator. This function performs the specific task that the generator is designed to do. See block 716. For example, for a “Create File” generator, the function implemented in block 716 creates a single file object. Next, the process 704 implements a function containing any code which needs to be executed after each occurrence of object generation. See block 718. For example, for a “Create File” generator, the function implemented in block 718 may disconnect the network connection to the server specified by the property “file path”. The process 704 then proceeds from exit terminal B.

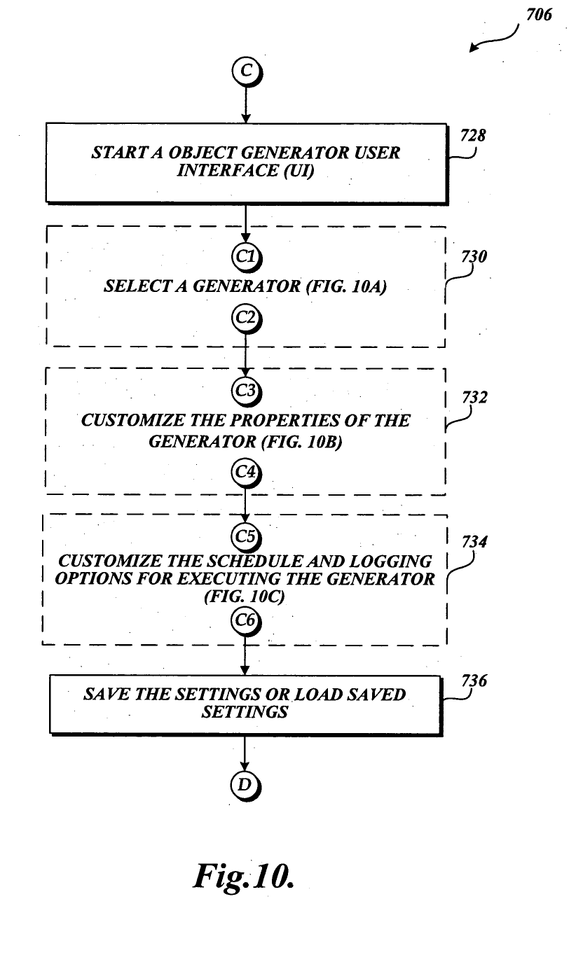

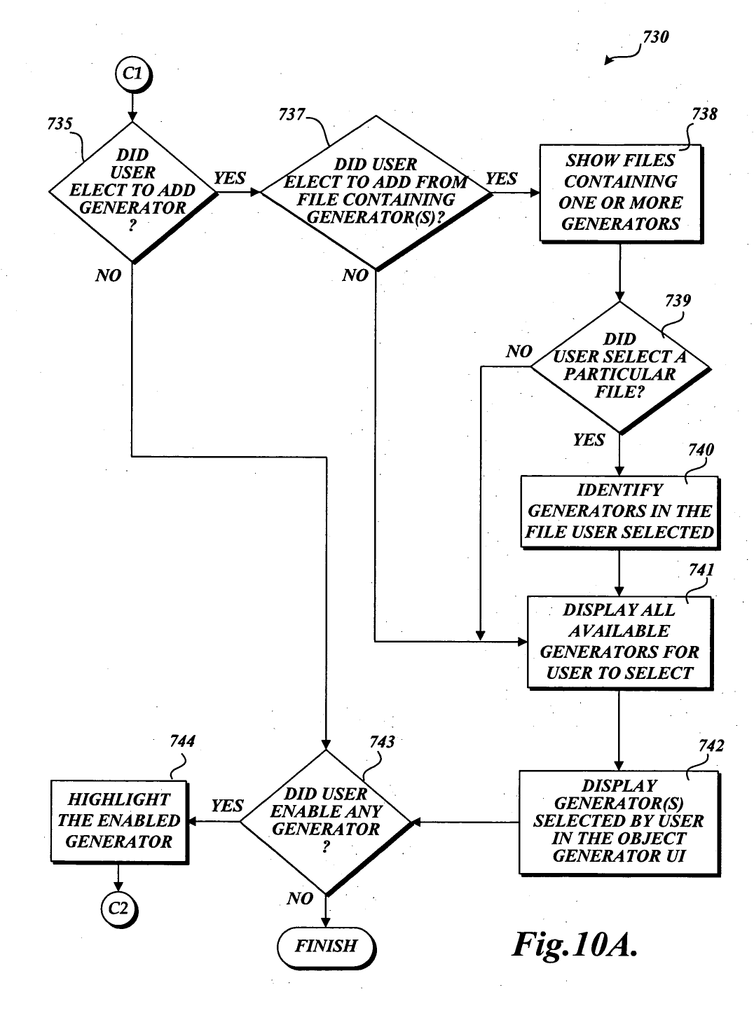

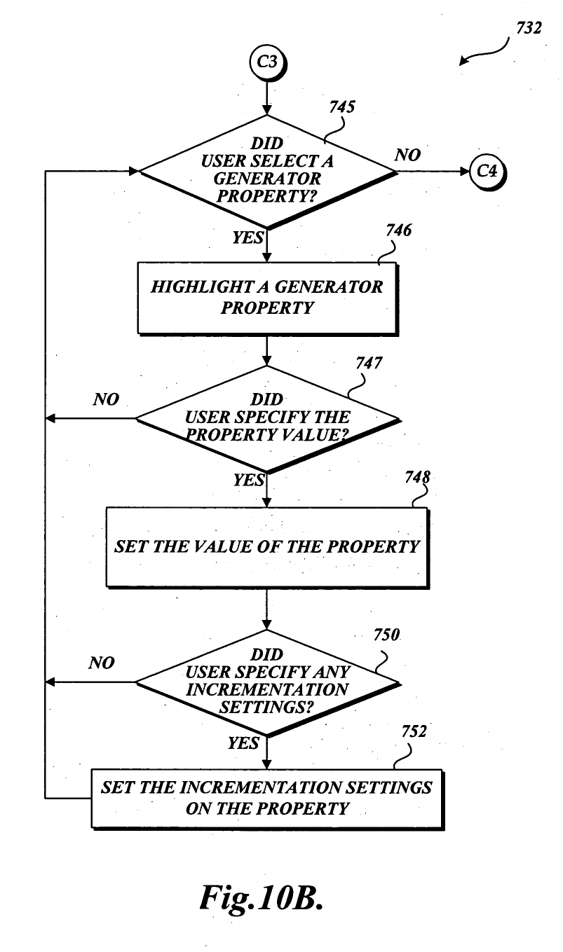

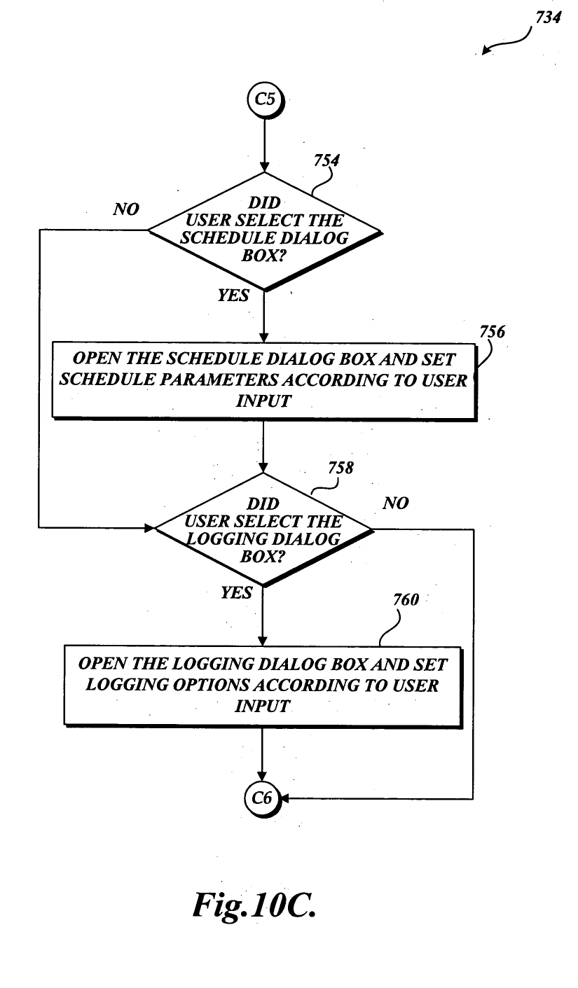

From terminal B (FIG. 7), the method 700 next proceeds to a customization process 706, defined between continuation terminal (“terminal C”) and an exit terminal (“terminal D). The customization process 706 customizes the properties of a generator and the settings for each generator property either through a user interface or programmatically. FIG. 10 illustrates a suitable process 706.

From terminal C (FIG. 10), the process 706 opens or starts an object generator user interface. See block 728. The process 706 then proceeds to a process 730, defined between a continuation terminal (“terminal C1”) and an exit terminal (“terminal C2”) that provides for the selection of a generator through a user interface. FIG. 10A illustrates a suitable process 730.

From terminal C1 (FIG. 10A), a test is made to determine if the user has elected to add a generator. See decision block 735. If the answer is “yes,” the process 730 proceeds to test if the user elected to add generator(s) from files containing one or more generators. See decision block 737. If the answer to the test in decision block 735 is “no”, meaning that the user considers the generators displayed in the object generator user interface sufficient, the process 730 proceeds to test if the user has enabled any generator. See decision block 743.

A “yes” answer to the test in decision block 737 means that the user wants to load generators from files, such as a DLL that contains one or more generators. The process 730 then displays the files containing one or more generators. See block 738. If a user did not elect to add additional generator(s) from a file (a “no” answer to decision block 737), or if a user elected to add generator(s) from a file, but did not select any file (a “no” answer to decision block 739), the process 730 proceeds to display all generators already available for the user to select. See block 741.

Upon receiving notice that the user has selected a particular file containing one or more generators (a “yes” answer to decision block 739), the process 730 identifies the generators in the user selected file. See block 740. The process 730 identifies the generators by checking whether a class inherits from the base generator class and whether the class has a public default constructor. The process 730 then displays all available generators for the user to select. See block 741.

Upon receiving notice that the user has selected generators to use through the object generator user interface, among the available generators, the process 730 displays the user-selected generators in the object generator user interface. See block 742. The process 730 then proceeds to decision block 743.

If a user has enabled any generator for object generation in an object generator user interface (a “yes” answer to decision block 743), the process 730 highlights the generator(s) enabled by the user. See block 744. The process 730 then proceeds to exit terminal C2. If the answer to decision block 743 is “no”, meaning the user has enabled no generator to execute, the method 700 finishes.

From exit terminal C2 (FIG. 10), the process 706 proceeds to a process 732, defined between a continuation terminal (“terminal C3”) and an exit terminal (“terminal C4”). The process 732 provides for the customization of the property settings of a selected generator through a user interface. FIG. 10B illustrates a suitable process 732.

From terminal C3 (FIG. 10B), a test is made to determine if the user selected a generator property. See decision block 745. If the answer is “yes”, the property is highlighted. See block 746. The process 732 then proceeds to test if the user specified a value for the property. See decision block 747. If the user did not specify a value for the property, the process 732 loops back to decision block 745 to see if the user has selected another property to customize. If the user did specify a property value, the process 732 sets the property value accordingly. See block 748. The process 732 then proceeds to test if the user entered any value for the incrementation settings. See decision block 750. If the user did not customize the incrementation settings, the process 732 loops back to decision block 745 to see if the user has selected another property to customize. If the user did customize the incrementation settings, the process 732 sets the values for the incrementation settings accordingly. The process 732 then checks to determine if the user has selected another property to customize by looping back to decision block 745. If the answer to decision block 745 is “no”, the process 732 exits through terminal C4.

From terminal C4 (FIG. 10), the process 706 proceeds to a process 734, defined between a continuation terminal (“terminal C5”) and an exit terminal (“terminal C6”). The process 734 sets object generation scheduling and logging options according to user input through the object generator user interface. FIG. 10C illustrates a suitable process 734.

From terminal C5 (FIG. 10C), the process 734 proceeds to test if the user has selected the schedule dialog box (See decision block 754) and/or the logging dialog box (See decision block 758). If the user has selected either one or both, the process 734 opens up the corresponding dialog box to accept user input. The process 734 then customizes the settings according to user input. See block 756 and block 760. The process 734 then exits via terminal C6. If the user did not select either the schedule dialog box or the logging dialog box, the process 734 exits via terminal C6 as well.

From terminal C6 (FIG. 10), the process 706 proceeds to save the customized settings. See block 736. The saved settings may be loaded for use the next time a user deploys this generator. The process 706 then exits via terminal D.

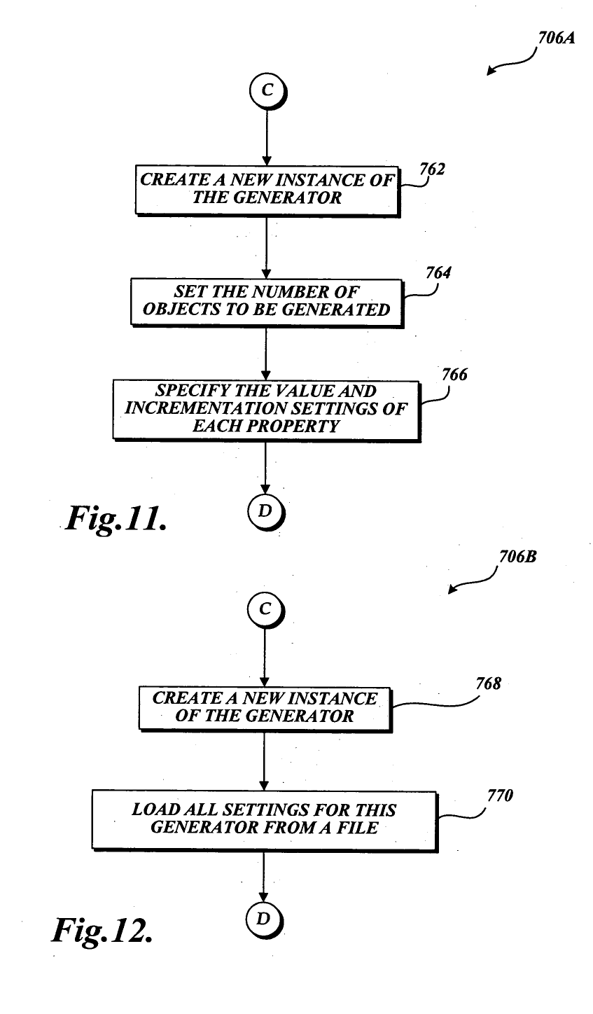

FIGS. 11-15 illustrate different processes 706A, 706B, 706C, 706D, and 706E, where customizing generator settings is done programmatically, i.e., by user created coding. Thus, FIGS. 11-15 describe alternatives to the user information process illustrated in FIGS. 10, 10A, 10B, and 10C.

From terminal C (FIG. 11), process 706A proceeds by coding that creates a new instance of the generator. See block 762. The coding then sets the number of objects to be generated. See block 764. The coding then sets the values of the properties used by this generator, and the incrementation settings for each incrementable property. See block 766. The process 706A exits via terminal D.

FIG. 12 illustrates another process 706B for customizing generator settings programmatically. From terminal C, the process 706B proceeds to create coding that creates a new instance of the generator. See block 768. The coding then loads saved settings for the generator from a file. See block 770. The process 706B then exits via terminal D.

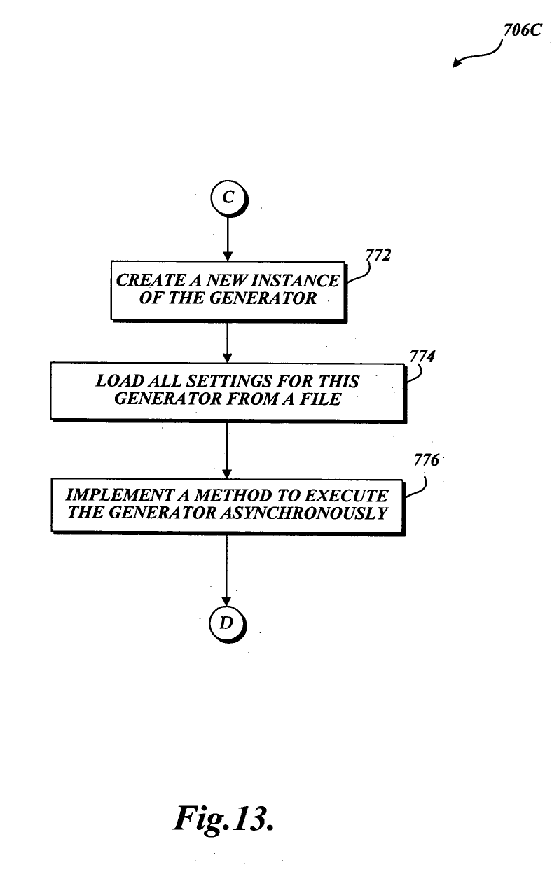

FIG. 13 illustrates another process 706C for customizing generator settings programmatically. From terminal C, the process 706C proceeds to coding that creates a new instance of the generator. See block 772. The coding then loads saved settings for this generator from a file. See block 774. The coding then implements a method to execute the generator asynchronously. See block 776. The process 706C then exits via terminal D.

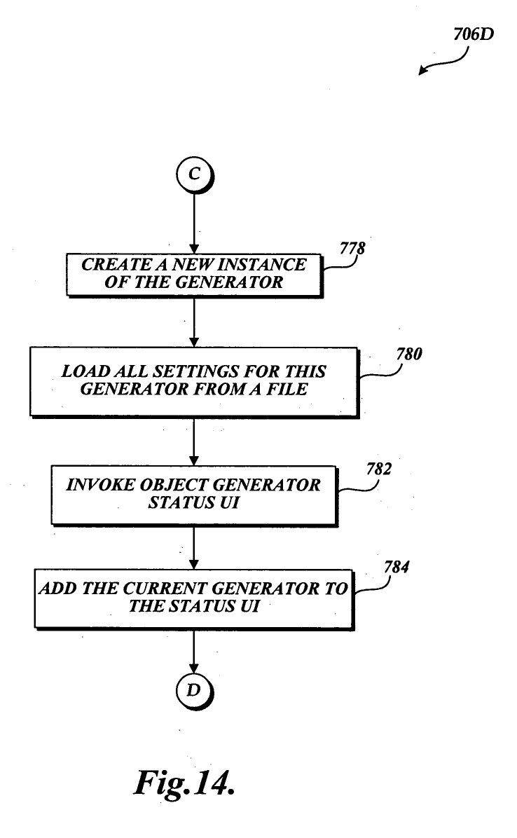

FIG. 14 illustrates yet another process 706D for customizing generator settings programmatically. From terminal C, the process 706D proceeds to coding that creates a new instance of the generator. See block 778. The coding then loads saved settings for this generator from a file. See block 780. The coding then invokes a status UI for object generation. See block 782. The coding then adds the current generator to the status UI for object generation. See block 784. The process 706D then exits via terminal D.

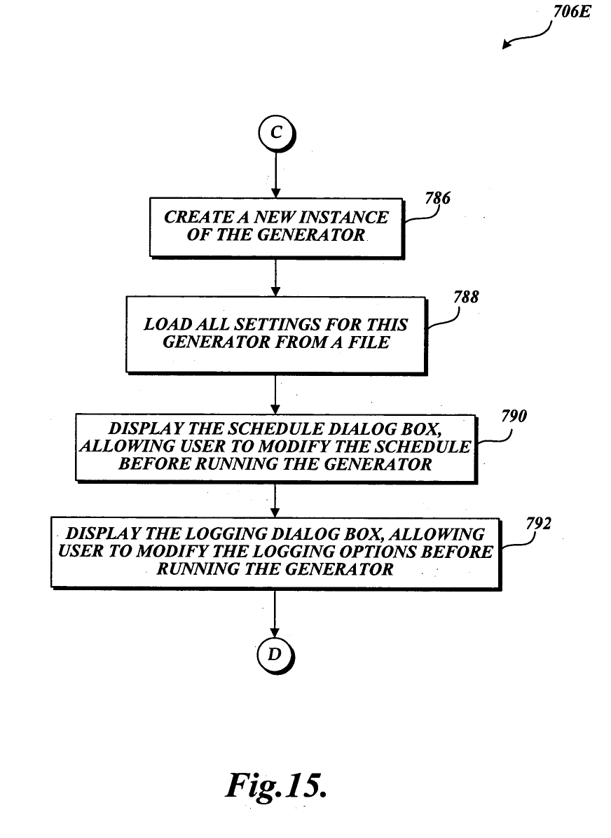

FIG. 15 illustrates a further process 706E for customizing generator settings programmatically. From terminal C, the process 706E proceeds to coding that creates a new instance of the generator. See block 786. The coding then loads saved settings for this generator from a file. See block 788. The coding then invokes a schedule dialog box to allow a user to modify the generator schedule before running the generator. See block 790. The coding then invokes a logging dialog box allow a user to modify the logging options before running the generator. See block 792. The process 706E then exits via terminal D.

From terminal D (FIG. 7), the method 700 proceeds to execute the generator with customized settings when a user clicks on a “start generator” link 540 on the user interface 500 illustrated in FIG. 5A. The execution may also be initiated by a user programmatically. See block 708.

As those of skill in the art recognize, the exemplary embodiments of the present invention may be embodied and/or implemented in both hardware and software, or a combination of both. For example, the exemplary embodiments of the present invention may be programmed using a programming language and stored on a storage medium for use by a system having processing capability. Furthermore, the exemplary embodiments of the present invention may be implemented in hardware, such as a semiconductor device or the like, that may be integrated into a system designed to access and make use of the hardware.

While the presently preferred embodiment of the invention has been illustrated and described, it will be appreciated that various changes can be made therein without departing from the spirit and scope of the invention as defined by the appended claims.

1. A computer-readable medium having a base generator class stored thereon for use by developers to create generators to perform specific tasks, the base generator class comprising:
a base generator class constructor;
a generator properties object that provides incrementation capability, which allows the value of a generator property to vary during consecutive executions of a generator;
a status indicator;
a schedule object; and
a logging object.

2. The computer-readable medium of claim 1, wherein the generator properties object that provides incrementation capability includes a plurality of generator properties.

3. The computer-readable medium of claim 2, wherein said plurality of generator properties includes:
a value of a generator property;
a plurality of incrementation settings;
a default incrementor that changes the value of the generator property; and
a default validator that validates the value of the generator property.

4. The computer-readable medium of claim 1, wherein the status indicator includes a status user interface (UI) for displaying the execution status of generators.

5. The computer-readable medium of claim 1, wherein the schedule object comprises:
a start condition under which the execution of a generator may be started;
a recurrence condition under which the execution of a generator may recur;
an end condition under which the execution of a generator stops; and
a dialog box that can be used to accept user input.

6. The computer-readable medium of claim 1, wherein the logging object enables the recording of the execution process of a generator.

7. A method of creating a generator, wherein the generator performs a specific task such as creating a file, comprising:
creating a new generator class that inherits a base generator class that contains incrementation capability;
creating a public default constructor for the new generator class that overrides the base generator class constructor; and
implementing a function in the new generator class to perform the specific task.

8. The method of claim 7, wherein creating a public default constructor comprises:
initializing the base generator class constructor with the name and the description of the generator; and
defining the properties of the generator.

9. The method of claim 8, wherein defining properties for the generator comprises:
(a) defining the name of a property;
(b) setting a default value for the property;
(c) providing a description for the property;
(d) specifying incrementation settings for the property;
(e) creating a custom property incrementor, if applicable;
(f) creating a custom property validator, if applicable; and
(g) repeating (a)-(f) for all properties of the generator.

10. The method of claim 7, further comprising implementing a function to be executed before each execution of a generator.

11. The method of claim 7, further comprising implementing a function to be executed after each execution of a generator.

12. A method of using a generator that performs a specific task such as creating a file, comprising:
customizing the settings of a generator, including incrementation settings that specify how the value of a generator property may vary between generated objects; and
executing the generator with the customized settings.

13. The method of claim 12, customizing the settings of a generator, is accomplished through a user interface.

14. The method of claim 13, further comprising:
starting a object generator user interface;
selecting a generator; and
customizing properties of the generator;

15. The method of claim 14, selecting a generator further comprising adding a generator from files containing one or more generators.

16. The method of claim 14, further comprising loading the settings of a generator from a file.

17. The method of claim 14, wherein customizing the properties of the generator comprises:
(a) selecting a property;
(b) specifying the value of the property;
(c) specifying the incrementation settings of the property; and
(d) repeating (a)-(c) until there are no more properties to be customized.

18. The method of claim 14, further comprising setting a schedule for executing the generator.

19. The method of claim 14, further comprising setting logging options for executing the generator.

20. The method of claim 14, further comprising saving the settings of the generator.

21. The method of claim 12, customizing the settings of a generator, is accomplished programmatically.

22. The method of claim 21, further comprising:
creating a new instance of the generator;
setting the number of objects to be generated by the generator; and
customizing the properties of the generator.

23. The method of claim 22, wherein customizing the properties of the generator comprises:
(a) setting the value of a property;
(b) specifying the incrementation settings of the property; and
(c) repeating (a)-(b) until there are no more properties to be customized.

24. The method of claim 21, further comprising:
creating a new instance of the generator; and
loading saved settings of the generator from a file.

25. The method of claim 21, further comprising:
creating a new instance of the generator;
loading saved settings of the generator from a file; and
implementing a function to execute the generator asynchronously.

26. The method of claim 21, further comprising:
creating a new instance of the generator;
loading saved settings of the generator from a file;
displaying an object generation status UI; and
adding the generator to the object generation status UI.

27. The method of claim 21, further comprising:
creating a new instance of the generator;
loading saved settings of the generator from a file;
displaying a schedule dialog box that allows a user to specify a schedule for executing the generator; and
displaying a logging dialog box that allows a user to specify logging options for executing the generator.

28. The method of claim 12, further comprising executing the generator through a user interface.

29. The method of claim 12, further comprising executing the generator programmatically.

30. A method for object generation using a base generator class, comprising:
creating a generator that performs a specific task;
customizing the settings of the generator, including incrementation settings that specify how the value of a generator property may vary between generated objects; and
executing the generator with the customized settings.

31. The method of claim 30, wherein creating a generator that performs a specific task comprises:
creating a new generator class that inherits the base generator class;
creating a public default constructor for the new generator class that overrides the base generator class constructor; and
implementing a function in the new generator class to perform a specific task.

32. The method of claim 31, creating a public default constructor further comprising:
initializing the base generator class constructor with the name and the description of the generator; and
defining the properties of the generator.

33. The method of claim 32, wherein defining properties for the generator includes
(a) defining the name of a property;
(b) setting a default value for the property;
(c) providing a description for the property;
(d) specifying the incrementation settings for the property;
(e) creating a custom property incrementor, if applicable;
(f) creating a custom property validator, if applicable; and
(g) repeating (a)-(f) for all properties of the generator.

34. The method of claim 31, further comprising implementing a function to be executed before each execution of a generator.

35. The method of claim 31, further comprising implementing a function to be executed after each execution of a generator.

36. The method of claim 30, customizing the settings of a generator is accomplished through a user interface.

37. The method of claim 36, further comprising:
starting an object generator user interface;
selecting a generator; and
customizing the properties of the generator;

38. The method of claim 37, wherein selecting a generator comprises adding a generator from files containing one or more generators.

39. The method of claim 37, further comprising loading generator settings from a file.

40. The method of claim 37, wherein customizing the properties of the generator comprises:
(a) selecting a property;
(b) specifying the value of the property;
(c) specifying the incrementation settings of the property; and
(d) repeating (a)-(c) until there are no more properties to be customized.

41. The method of claim 37, further comprising setting a schedule for executing the generator.

42. The method of claim 37, further comprising setting logging options for executing the generator.

43. The method of claim 37, further comprising saving the settings of the generator.

44. The method of claim 30, customizing the property settings of a generator is accomplished programmatically.

45. The method of claim 44, further comprising:
creating a new instance of the generator;
setting the number of objects to be generated by the generator; and
customizing the properties of the generator.

46. The method of claim 45, wherein customizing the properties of the generator comprises:
(a) setting the value of a property;
(b) specifying the incrementation settings of the property; and
(c) repeating (a)-(b) until there are no more properties to be customized.

47. The method of claim 44, further comprising:
creating a new instance of the generator; and
loading saved settings of the generator from a file.

48. The method of claim 44, further comprising:
creating a new instance of the generator;
loading saved settings of the generator from a file; and
implementing a method to execute the generator asynchronously.

49. The method of claim 44, further comprising:
creating a new instance of the generator;
loading saved settings of the generator from a file;
displaying an object generation status UI; and
adding the current generator to the object generation status UI.

50. The method of claim 44, further comprising:
creating a new instance of the generator;
loading saved settings of the generator from a file;
displaying a schedule dialog box that allows a user to specify a schedule for executing the generator; and
displaying a logging dialog box that allows a user to specify logging options for executing the generator.

51. The method of claim 30, further comprising executing the generator through a user interface.

52. The method of claim 30, further comprising executing the generator programmatically.

53. A method of varying the value of a property associated with a task, during consecutive executions of the task, comprising:
allowing the value of the property to vary during consecutive executions of the task;
creating settings associated with the property that control how the value may vary during consecutive executions of the task; and
allowing a user executing the task to customize the settings according to user preference.

54. The method of claim 53, wherein the step of allowing the value of the property to vary during consecutive executions of the task further comprises:
implementing a function that increments a property value according to the settings associated with the property that control how the value may vary during consecutive executions of the task.

55. A computer-readable medium containing computer-executable instructions for a method of varying the value of a property associated with a task, during consecutive executions of the task, the method comprising:
allowing the value of the property to vary during consecutive executions of the task;
creating settings associated with the property that control how the value may vary during consecutive executions of the task; and
allowing a user executing the task to customize the settings according to user preference.

56. The computer-readable medium of claim 55, wherein the step of allowing the value of the property to vary during consecutive executions of the task further comprises:
implementing a function that increments a property value according to the settings associated with the property that control how the value may vary during consecutive executions of the task.
